(19) United States
(12) Patent Application Publication
(10) Pub. No.: US 2015/0356836 A1
(43) Pub. Date: Dec. 10, 2015

(54) CONVERSATION CUES WITHIN AUDIO CONVERSATIONS

(71) Applicant: Microsoft Corporation, Redmond, WA (US)

(72) Inventors: Benny Schlesinger, Ramat Hasharon (IL); Guy Kashtan, Tel Aviv (IL); Saar Yahalom, Hertzlyia (IL)

(21) Appl. No.: 14/297,009

(22) Filed: Jun. 5, 2014

(51) Int. Cl. G08B 3/10; H04R 1/10; G10L 15/26

(52) U.S. Cl. CPC G08B 3/10; G10L 15/265; H04R 1/105

(57) ABSTRACT

In many scenarios, a device may detect one or more audio conversations, and may be capable of evaluating such audio conversations, e.g., in order to present a text transcript to a user. However, the user's attention to such audio conversations may waver, and the user may miss the audio conversation and/or an opportunity to participate in the audio conversation. Presented herein are techniques for enabling devices to assist users in such scenarios by monitoring audio conversations to detect conversation cues that pertain to the user (e.g., the user's name, names of the user's friends, and/or topics of interest to the user). Upon detecting a conversation cue within an audio conversation that pertains to the user, the device notifies the user (e.g., alerting the user that the audio conversation may be of interest, and/or presenting a text transcript of the portion of the audio conversation containing the conversation cue).

### BACKGROUND

Within the field of computing, many scenarios involve a device operated by a user present during at least one audio conversation, such as an in-person conversation, a live conversation mediated by devices, and a recorded conversation replayed for the user. In such scenarios, devices may assist the user in a variety of ways, such as recording the audio conversation; transcribing the audio conversation as text; and tagging the audio conversation with metadata, such as the date, time, and location of the conversation.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

A significant aspect of audio conversations that may affect a user of a device is the limited attention of the user. As a first example, the user's attention may drift from the current audio conversation to other topics, and the user may miss parts of the audio conversation that are relevant to the user. As a second example, when two or more conversations are occurring concurrently, the user may have difficulty listening to and/or participating in all such conversations, and/or may have difficulty selecting among the concurrent conversations as the focus of the user's attention. Accordingly, the user may miss pertinent conversation in one such conversation due to the direction of the user's attention toward a different conversation. As a third example, a device that passively assists the user in monitoring a conversation, such as a recorder or a transcriber, may be unsuitable for providing assistance during the conversation; e.g., the user may be able to review an audio recording and/or text transcript of the audio conversation at a later time in order to identify pertinent portions of the conversation, but may be unable to utilize such resources during the conversation without diverting the user's attention from the ongoing conversation.

Presented herein are techniques for configuring a device to apprise a user about conversations occurring in the proximity of the user. In accordance with these techniques, the device may detect one or more audio conversations arising within an audio stream, such as an audio feed of the current environment of the device, a live or recorded audio stream provided over a network such as the internet, and/or a recorded audio stream that is accessible to the device. The device may further monitor one or more of the conversations to detect a conversation cue that is pertinent to the user, such as the recitation of the user's name, the user's city of residence, and/or the user's workplace. Upon detecting such a conversation cue, the device may present a notification of the conversation cue to the user (e.g., as a recommendation to the user to give due attention to the audio conversation in which the conversation cue has arisen). In this manner, a device may be configured to apprise the user about the conversations occurring in the proximity of the user in accordance with the techniques presented herein.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is an illustration of various scenarios featuring a device facilitating an audio conversation of a user.

FIG. 2 is an illustration of an exemplary scenario featuring a device facilitating an audio conversation of a user by monitoring the audio conversation to detect at least one conversation cue and presenting to the user a notification of the conversation cue arising within the conversation in accordance with the techniques presented herein.

FIG. 3 is an illustration of an exemplary method of configuring a device to apprise a user of conversations in accordance with the techniques presented herein.

FIG. 4 is an illustration of an exemplary system for configuring a device to apprise a user of conversations in accordance with the techniques presented herein.

FIG. 5 is an illustration of an exemplary computer-readable medium comprising processor-executable instructions configured to embody one or more of the provisions set forth herein.

FIG. 6 is an illustration of an exemplary device in which the techniques provided herein may be utilized.

FIG. 7 is an illustration of an exemplary scenario featuring a device configured to apprise a user of conversations on which the user is not placing attention in accordance with the techniques presented herein.

FIG. 8 is an illustration of an exemplary scenario featuring a device configured to monitor respective conversations according to a conversation type in accordance with the techniques presented herein.

FIG. 9 is an illustration of an exemplary scenario featuring scenarios in which a device refrains from monitoring conversations on behalf of a user in accordance with the techniques presented herein.

FIG. 10 is an illustration of an exemplary scenario featuring a presentation of an audio notification of a conversation cue in accordance with the techniques presented herein.

FIG. 11 is an illustration of an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

### A. Introduction

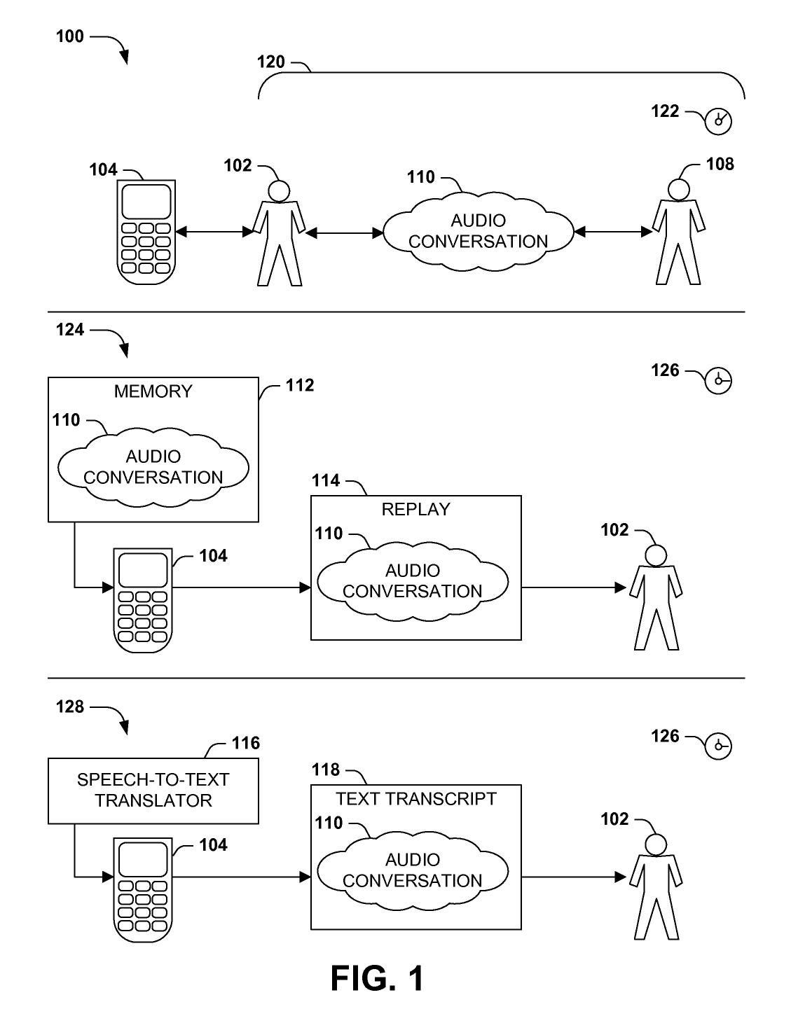

FIG. 1 is an illustration of an exemplary scenario 100 featuring a set of techniques by which a device 104 may facilitate a user 102 in relation to an audio conversation 110 with an individual 108.

In this exemplary scenario 100, at a first time point 122, the user 102 of the device 104 may be present 120 with another individual 108, and may be engaged in an audio conversation 110 with the individual 108. The audio conversation 110 may occur, e.g., as an in-person vocal conversation, and/or as a remote vocal conversation, such as a telephone call or voice-over-internet-protocol (VoIP) session. The user 102 may engage the device 104 to facilitate the audio conversation 110 in a variety of ways. As a first such example 124, at a second time point 126, the user 102 may request the device 104 to present a replay 114 of the audio conversation 110 with the individual 108. If the device 104 has stored the audio conversation 110 in a memory 112, such as a random-access memory (RAM) semiconductor, a platter of a hard disk drive, a solid-state storage device, and a magnetic and/or optical disc, then the device 104 may retrieve the audio conversation 110 from the memory 112 and present a replay 114 to the user 102. As a second such example 128, at the second time point 126, the user 102 may request to review a text transcript 118 of the audio conversation 110, such as a transcript provided by applying a speech-to-text translator 116 to the audio conversation 110. The device 104 may have previously applied the speech-to-text translator 116 to the audio conversation 110 (e.g., at the first time point 122 while the audio conversation 110 is occurring between the user 102 and the individual 108). Alternatively, the device 104 may have stored the audio conversation 110 in a memory 112, and may apply the speech-to-text translator 116 at the second time point 126 upon receiving the request from the user 102, or prior to receiving such request (i.e., between the first time point 122 and the second time point 126). In either variation, the device 104 may provide the text transcript 118 of the audio conversation 110 to the user 102. As a third such example (not shown), the device 104 may associate a variety of metadata with the audio conversation 110, such as the date, time, location, identities of participants, and/or a scheduled meeting at which the audio conversation 110 occurred. In such ways, the device 104 may apprise the user 102 of the content of the conversation.

While the techniques provided in the exemplary scenario 100 of FIG. 1 for configuring a device 104 to apprise a user 102 of an audio conversation 110 may provide some advantages to the user 102, it may be appreciated that some disadvantages may also arise through the application of such techniques.

As a first such example, the techniques illustrated in the exemplary scenario 100 may be difficult to utilize in a near-realtime basis, e.g., during the audio conversation 110 with the individual 108. For example, in order to review a replay 114 and/or a text transcript 118 of the audio conversation 110 (e.g., in order to revisit an earlier comment in the audio conversation 110, or to resolve a dispute over the earlier content of the audio conversation 110), the user 102 may have to suspend the audio conversation 110 with the individual 108 while reviewing such a replay 114 or text transcript 118, and then resume the audio conversation 110 after completing such review. Such suspension and resumption may be overt and awkward in particular scenarios, and/or may entail a wait for the individual 108 while the user 102 conducts such review.

As a second such example, the presentation of the replay 114 and/or text transcript 118 as provided in the exemplary scenario 100 of FIG. 1 are comparatively passive. That is, the user 102 may be interested in particular content of the audio conversation 110, such as a particular topic of discussion, but the device 104 in this exemplary scenario 100 does not assist the user 102 in determining where and/or whether such topic arose during the audio conversation 110. Even if such topic occurred during the audio conversation 110, the user 102 may not be aware of the occurrence of the topic (e.g., the user's attention may have drifted during the pertinent portion of the audio conversation 110), and the user 102 may not think to review the replay 114 and/or text transcript 118 in order to identify the portions of the audio conversation 110 relating to the specified topic.

As a third such example, the user 102 may be present during the occurrence of two or more concurrent audio conversations 110. Due to limited attention, the user 102 may have to choose among the at least two audio conversations 110 in order to direct attention at a selected audio conversation 110. The presentation of the replay 114 or text transcript 118 by the device 104 may not provide significant assistance in choosing among such audio conversations 110; e.g., the user 102 may later discover that, while the user's attention was directed to a first audio conversation 110, a second audio conversation 110 arose in which the user 102 wished to participate (e.g., an audio conversation 110 involving a topic of personal interest to the user 102). The user 102 may therefore have missed the opportunity to participate, and was not assisted by the device 104 in this regard. In these and other ways, the configuration of the device 104 as provided in the exemplary scenario 100 of FIG. 1 may present some limitations in apprising the user 102 of audio conversations 110.

### B. Presented Techniques

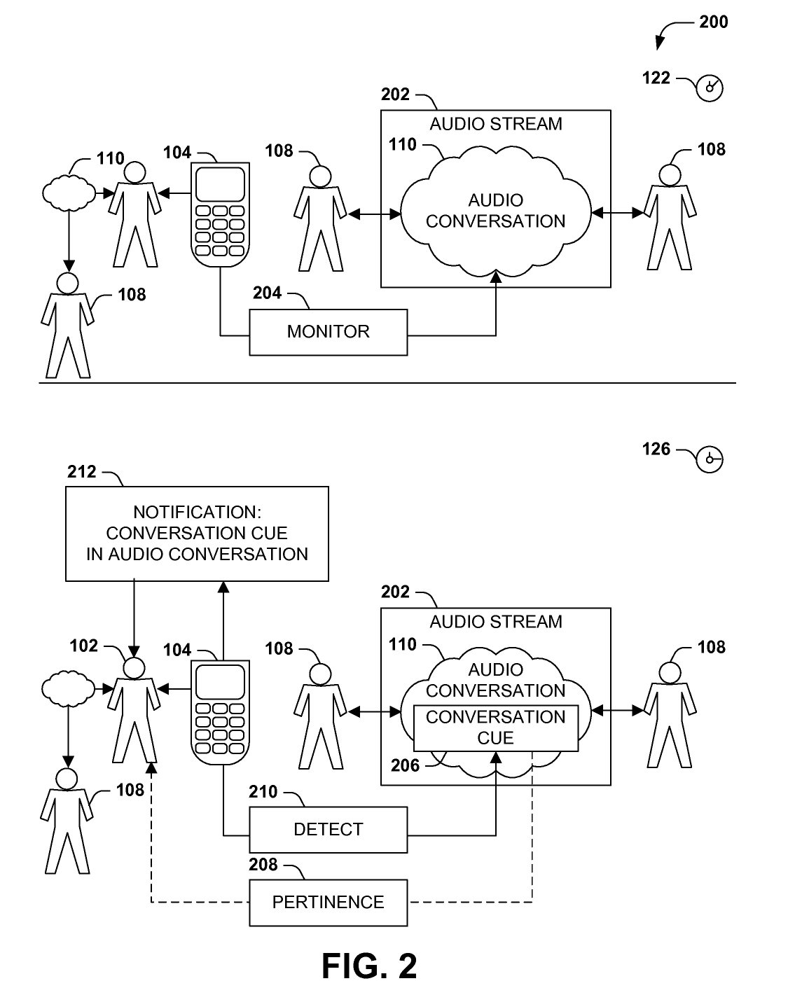

FIG. 2 presents an illustration of an exemplary scenario 200 featuring a configuration of a device 104 to apprise the user 102 of audio conversations 110 occurring in the vicinity of the user 102.

In this exemplary scenario 200, at a first time point 122, an audio conversation 110 among at least two individuals 108 may arise in the vicinity of the user 102. The user 102 may or may not be involved in the audio conversation 110; e.g., the user 102 may actively participating in the audio conversation 110, passively listening to the audio conversation 110, and/or actively participating in a different, concurrent audio conversation 110 with another individual 108. At the first time 122, the device 104 may detect the audio conversation 110 within an audio stream 202 (e.g., input from a microphone of the device 104), and may monitor 204 the audio conversation 110 for conversation cues 206 that may be of interest to the user 102. At a second time 126, when the device 104 detects 210 a conversation cue 206 arising within the audio conversation 110 having pertinence 208 to the user 102 (e.g., a comment about the user 102, a friend of the user 102, and/or a topic of interest to the user 102), the device 104 may present to the user 102 a notification 212 of the conversation cue 206 arising within the audio conversation 110. In this manner, the device 104 may actively apprise the user 102 of content arising within audio conversations 110 that is pertinent to the user 102 in accordance with the techniques presented herein.

### C. Technical Effects

The application of the presently disclosed techniques within a variety of circumstances may provide a range of technical effects.

As a first such example, the presentation of a notification 212 to the user 102 upon detecting a conversation cue 206 in an audio conversation 110 of an audio stream 202 may enable the device 104 to alert the user 102 regarding interesting conversations according to the user's interests and/or circumstances. Such techniques may notify the user 102 about such audio conversations 110 in a manner that does not depend on the user 102 actively searching for such conversations 110, and/or may notify the user 102 about audio conversations 110 that the user 102 would otherwise not have discovered at all.

As a second such example, the active monitoring and notifying achieved by the techniques presented herein may enable the user 102 to discover audio conversations 110 of interest while such audio conversations 110 are occurring, when the user 102 may participate in the audio conversation 110, rather than reviewing a replay 114 and/or text transcript 118 of the audio conversation 110 at a later time, after the audio conversation 110 has concluded.

As a third such example, the active monitoring may facilitate a conservation of attention of the user 102. As a first such example, the user 102 may not wish to pay attention to an audio conversation 110, but may wish to avoid missing pertinent information. Accordingly, the user 102 may therefore utilize the device 104 to notify the user 102 if pertinent information arises as a conversation cue 206, and may direct his or her attention to other matters without the concern of missing pertinent information in the audio conversation 110. As a second such example, the user 102 may be present while at least two audio conversations 110 are occurring, and may have difficulty determining which audio conversation 110 to join, and/or may miss pertinent information in a first audio conversation 110 while directing attention to a second audio conversation 110. A device 104 configured as presented herein may assist the user 102 in choosing among such concurrent audio conversations 110 in a manner that exposes the user 102 to pertinent information. As a third such example, the user 102 may be referenced in an audio conversation 110 in a manner that prompts a user response (e.g., a question may be directed to the user 102), and configuring the device 104 to notify the user 102 of the reference may prompt the user 102 to respond, rather than unintentionally revealing that the user 102 is not directing attention to the audio conversation 110. These and other technical effects, including those enabled by a wide range of presently disclosed variations, may be achievable in accordance with the techniques presented herein.

### D. Exemplary Embodiments

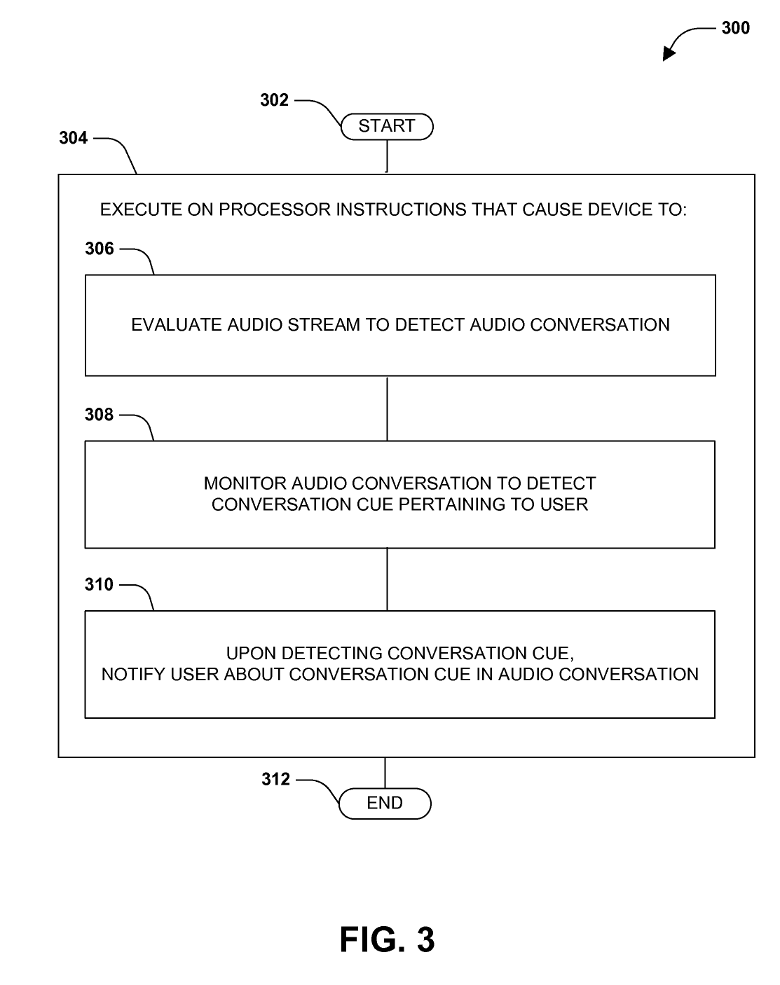

FIG. 3 presents a first exemplary embodiment of the techniques presented herein, illustrated as an exemplary method 300 of apprising a user 102 about audio conversations 110. The exemplary method 300 involves a device 104 having a processor that is capable of executing instructions that cause the device to operate according to the techniques presented herein. The exemplary method 300 may be implemented, e.g., as a set of instructions stored in a memory component of the device 104, such as a memory circuit, a platter of a hard disk drive, a solid-state storage device, or a magnetic or optical disc, and organized such that, when executed on a processor of the device 104, cause the device 104 to operate according to the techniques presented herein. The exemplary method 300 begins at 302 and involves executing 304 the instructions on a processor of the device 104. Specifically, the instructions cause the device 104 to evaluate 306 an audio stream 202 to detect an audio conversation 110. The instructions also cause the device 104 to monitor 308 the audio conversation 110 to detect a conversation cue 206 pertaining to the user 102. The instructions also cause the device 104 to, upon detecting the conversation cue 206 in the audio conversation 110, notify 310 the user 102 about the conversation cue 206 in the audio conversation 110. Having achieved the notification of the user 102 regarding the pertinent conversation cue 206 in the audio conversation 110, the configuration of the device 104 in this manner enables at least some of the technical effects provided herein, and so the exemplary method 300 ends at 312.

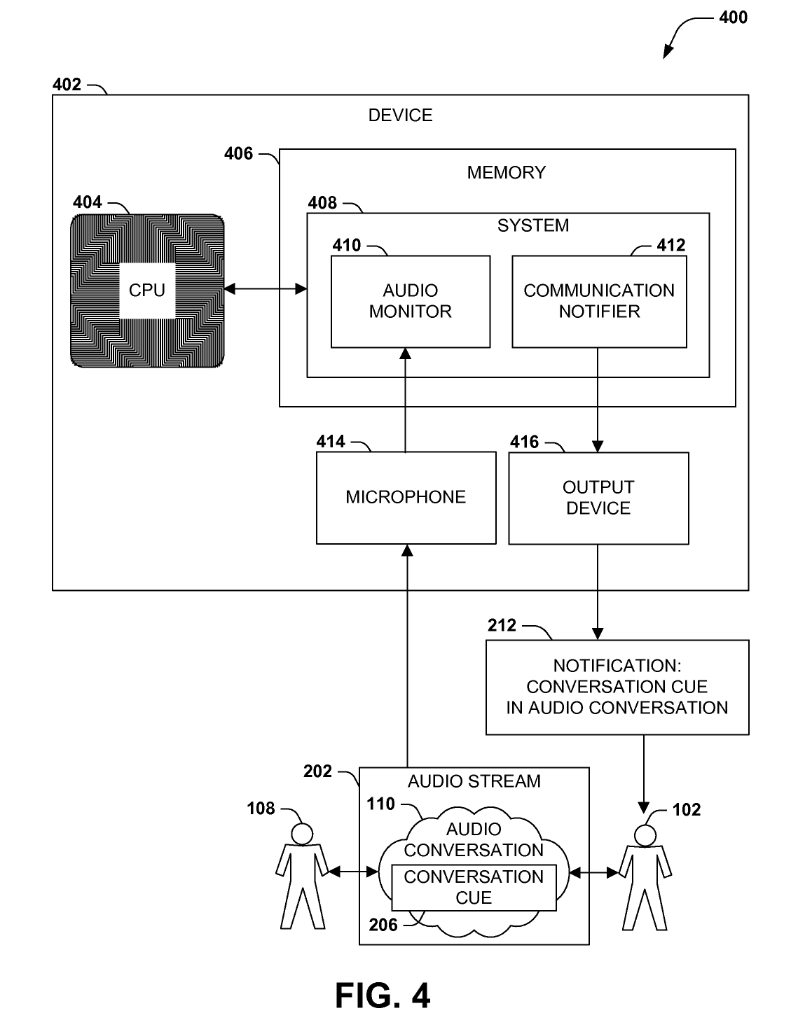

FIG. 4 presents a second exemplary embodiment of the techniques presented herein, illustrated as an exemplary scenario 400 featuring an exemplary system 408 configured to cause a device 402 to notify a user 102 of conversation cues 206 arising in audio conversations 110. The exemplary system 408 may be implemented, e.g., as a set of components respectively comprising a set of instructions stored in a memory 406 of the device 402, where the instructions of the respective components, when executed on a processor 404 of the device 402, cause the device 402 to perform a portion of the techniques presented herein. The particular device 402 illustrated in this exemplary scenario 400 also comprises a microphone 414 and an output device 416 that is capable of presenting a notification 212 to the user 102.

The exemplary system 406 includes an audio monitor 410 that detects an audio conversation 110 within an audio stream 202 detected by the microphone 414, and that monitors the audio conversation 110 to detect a conversation cue 206 pertaining to the user 102. The exemplary system 406 also includes a communication notifier 412 that, upon the audio monitor 410 detecting the conversation cue 206 in the audio conversation 110, notifies 212 the user 102 about the conversation cue 206 in the audio conversation 110. In this manner, the exemplary system 408 causes the device 402 to notify the user 102 of conversation cues 206 arising within audio conversations 110 in accordance with the techniques presented herein.

Still another embodiment involves a computer-readable medium comprising processor-executable instructions configured to apply the techniques presented herein. Such computer-readable media may include, e.g., computer-readable storage devices involving a tangible device, such as a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a CD-R, DVD-R, or floppy disc), encoding a set of computer-readable instructions that, when executed by a processor of a device, cause the device to implement the techniques presented herein. Such computer-readable media may also include (as a class of technologies that exclude computer-readable storage devices) various types of communications media, such as a signal that may be propagated through various physical phenomena (e.g., an electromagnetic signal, a sound wave signal, or an optical signal) and in various wired scenarios (e.g., via an Ethernet or fiber optic cable) and/or wireless scenarios (e.g., a wireless local area network (WLAN) such as WiFi, a personal area network (PAN) such as Bluetooth, or a cellular or radio network), and which encodes a set of computer-readable instructions that, when executed by a processor of a device, cause the device to implement the techniques presented herein.

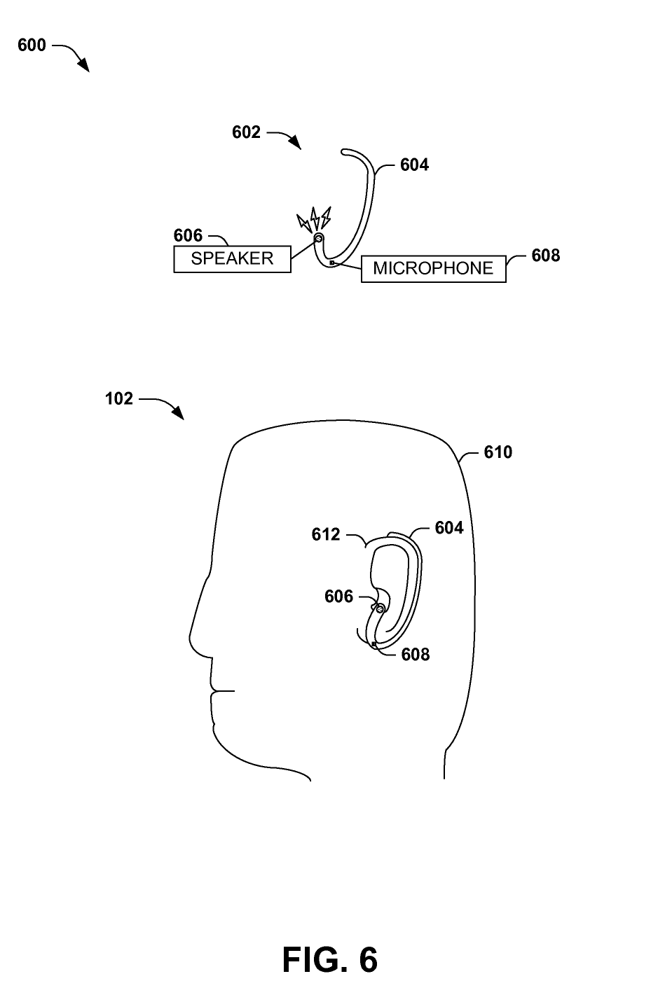

An exemplary computer-readable medium that may be devised in these ways is illustrated in FIG. 6, wherein the implementation 600 comprises a computer-readable memory device 502 (e.g., a CD-R, DVD-R, or a platter of a hard disk drive), on which is encoded computer-readable data 504. This computer-readable data 504 in turn comprises a set of computer instructions 506 that, when executed on a processor 404 of a computing device 510, cause the computing device 510 to operate according to the principles set forth herein. In a first such embodiment, the processor-executable instructions 506 may be configured to perform a method of apprising a user 102 of conversation cues 206 arising within audio conversations 110, such as the exemplary method 300 of FIG. 3. In a second such embodiment, the processor-executable instructions 506 may be configured to implement a system that causes the computing device 510 to apprise the user 102 of conversation cues 206 arising within the audio conversation 110, such as the exemplary system 408 of FIG. 4. Some embodiments of this computer-readable medium may comprise a computer-readable storage device (e.g., a hard disk drive, an optical disc, or a flash memory device) that is configured to store processor-executable instructions configured in this manner. Many such computer-readable media may be devised by those of ordinary skill in the art that are configured to operate in accordance with the techniques presented herein.

### E. Variations

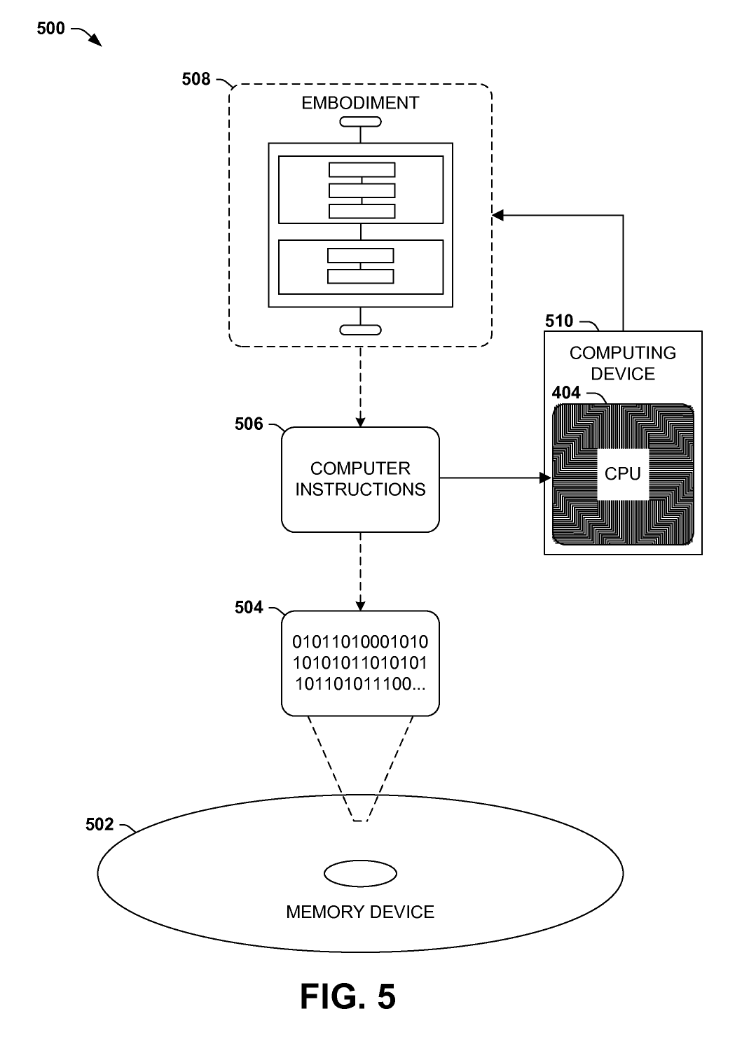

The techniques discussed herein may be devised with variations in many aspects, and some variations may present additional advantages and/or reduce disadvantages with respect to other variations of these and other techniques. Moreover, some variations may be implemented in combination, and some combinations may feature additional advantages and/or reduced disadvantages through synergistic cooperation. The variations may be incorporated in various embodiments (e.g., the exemplary method 300 of FIG. 3; the exemplary system 408 of FIG. 4; and the exemplary computer-readable memory device 502 of FIG. 5) to confer individual and/or synergistic advantages upon such embodiments.

E1. Scenarios

A first aspect that may vary among embodiments of these techniques relates to the scenarios wherein such techniques may be utilized.

As a first variation of this first aspect, the techniques presented herein may be utilized to achieve the configuration of a variety of devices 104, such as laptops, tablets, phones and other communication devices, headsets, earpieces, eyewear, wristwatches, portable gaming devices, portable media players such as televisions, and mobile appliances.

FIG. 6 presents an illustration of an exemplary scenario 600 featuring an earpiece device 602 wherein the techniques provided herein may be implemented. This earpiece device 602 may be worn by a user 102, and may include components that are usable to implement the techniques presented herein. For example, the earpiece device 602 may comprise a housing 602 wearable on the ear 612 of the head 610 of the user 102, and may include a speaker 606 positioned to project audio messages into the ear 612 of the user 102, and a microphone 608 that detects audio conversations 110 arising in the proximity of the user 102. In accordance with the techniques presented herein, the earpiece device 602 may apprise the user 102 of conversation cues 206 arising within such audio conversations 110, e.g., by invoking the speaker 606 to project audio, such as a sound cue signaling the presence of the conversation cue 206, into the ear 612 of the user 102. In this manner, an earpiece device 602 such as illustrated in the exemplary scenario 600 of FIG. 6 may utilize the techniques presented herein.

As a second variation of this first aspect, the techniques presented herein may also be utilized to achieve the configuration of a wide variety of servers to interoperate with such devices 104 to apprise users 102 of audio conversations 10, such as a cloud server that is accessible over a network such as the internet, and that assists devices 104 with apprising users 102 of audio conversations 110. For example, a user device, such as a phone or an earpiece 602, may be constrained by computational resources and/or stored power, and may seek to offload the evaluation of the audio conversation 110 to a server featuring plentiful computational resources and power. As another example, a user device may comprise a mobile device of the user 102, and the server may comprise a workstation device of the user 102 that is in communication with the mobile device over a personal-area network, such as a Bluetooth network. In such scenarios, when the user device is in communication with such a server, the user device may monitor the audio conversation 110 by sending at least a portion of the audio stream 202 to the server. The server may receive the portion of the audio stream 202 from the user device, and may evaluate the audio conversation 110 within the audio stream 202 to detect the occurrence of one or more conversation cues 206. Upon detecting such a conversation cue 206, the server may notify the user 102 by notifying the user device about the conversation cue 206 in the audio conversation 110. The user device may receive the notification from the server, and may present a notification 212 of the conversation cue 206 that informs the user 102 of the audio conversation 110. In this manner, a user device and a server may cooperatively achieve the techniques presented herein.

As a third variation of this first aspect, the techniques presented herein may be utilized to monitor a variety of types of audio conversations 110. As a first such example, the audio conversation 110 may arise in physical proximity to the user 102, such as a conversation between the user 102 and one or more individuals 108, or a conversation only among a group of individuals 108 who are standing or seated near the user 102, which the device 104 detects within the audio stream 202 received through a microphone 414. As a second such example, the audio conversation 110 may occur remotely, such as a phone call, a voice-over-internet-protocol (VoIP) session, or an audio component of a videoconference, which the device 104 receives as an audio stream transmitted over a network such as the internet.

As a fourth variation of this first aspect, the techniques presented herein may be utilized to detect many types of conversation cues 212 arising within such audio conversations 110. Such conversation cues 212 may comprise, e.g., the name of the user 102; the names of individuals 108 known to the user 102; the name of an organization with which the user 102 is affiliated; an identifier of a topic of interest to the user 102, such as the user's favorite sports team or novel; and/or an identifier that relates to the context of the user 102, such as a reference to the weather in a particular city that the user 102 intends to visit, or a reference to traffic on a road on which the user 102 intends to travel. Many such scenarios may be devised wherein the techniques presented herein may be utilized.

E2. Detecting and Monitoring Audio Conversations

A second aspect that may vary among embodiments of the techniques presented herein involves the manner of detecting and monitoring an audio conversation 110 presented in an audio stream 202.

As a first variation of this second aspect, the device 104 may use a variety of techniques to detect the audio conversation 110 within the audio stream 202. As a first such example, the device 104 may receive a notification that such audio conversation 110 is occurring within an audio stream 202, such as an incoming voice call that typically initiates an interaction between the individuals 108 attending the voice call, or a request from the user 102 to monitor audio conversations 110 detectable within the audio stream 202. As a second such example, the device 104 may detect frequencies arising within the audio stream 202 that are characteristic of human speech. As a third such example, the device 104 may identify circumstances that indicate a likelihood that an audio conversation 110 is occurring or likely to occur, such as detecting that the user 102 is present in a classroom or auditorium during a scheduled lecture or presentation. In one such embodiment, the device 104 may include a component that periodically and/or continuously monitors the audio stream 202 to detect an initiation of an audio conversation 202 (e.g., a signal processing component of a microphone), and may invoke other components to perform more detailed analysis of the audio conversation 202 after detecting the initiation of an audio conversation 202, thereby conserving the computational resources and/or stored power of the device 104.

As a second variation of this second aspect, the device 104 may be present during two or more audio conversations 110, and may be configured to distinguish a first audio conversation 110 and a second audio conversation 110 concurrently and/or consecutively present in the audio stream 202. For example, the device 104 may include an acoustic processing algorithm that is capable of separating two overlapping audio conversations 110 in order to allow consideration of the individual audio conversations 110. The device 104 may then monitor the first audio conversation 202 to detect a conversation cue 206 pertaining to the user 102. The device 104 may also, concurrently and/or consecutively, monitor the second audio conversation 202 to detect a conversation cue 206 pertaining to the user 102. The processing of conversation cues 206 in a plurality of audio conversations 202 may enable the device 102 to facilitate the user 102 in directing attention among the audio conversations 110; e.g., upon detecting a conversation cue 206 in an audio conversation 110 to which the user 102 is not directing attention, the device 104 may notify the user 102 to direct attention to the audio conversation 110.

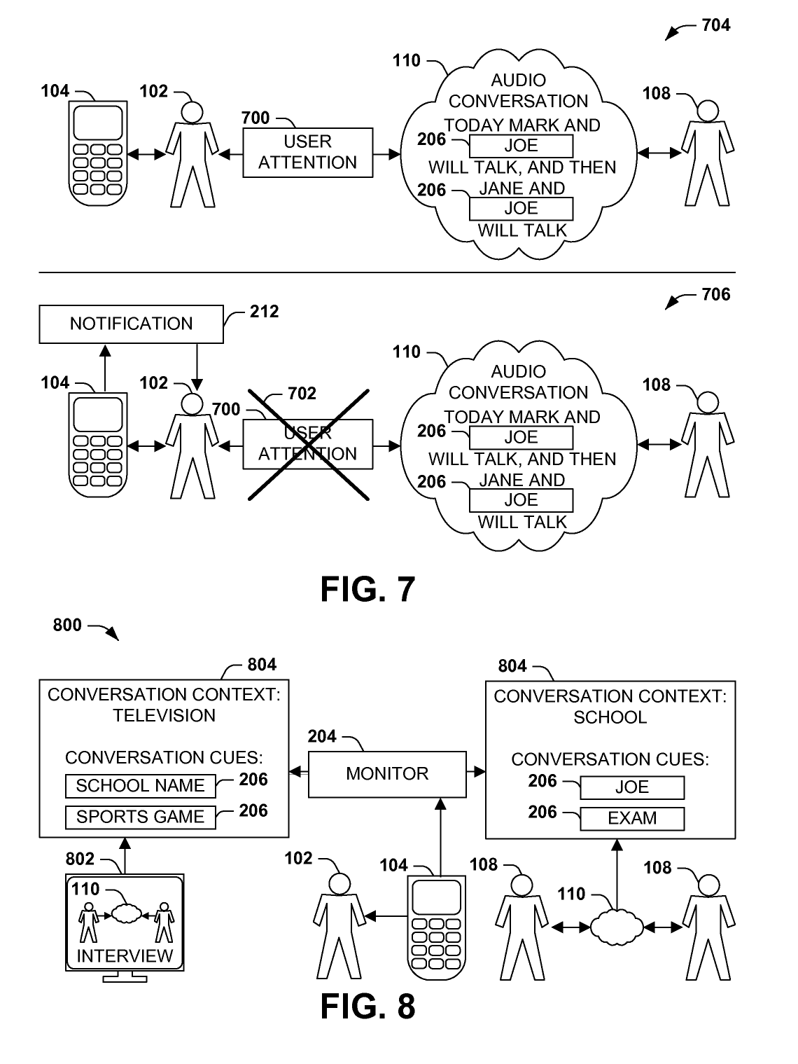

FIG. 7 presents an illustration of an exemplary scenario featuring a third variation of this second aspect. In this exemplary scenario, the device 104 may distinguish when the user 102 is directing user attention 700 to an audio conversation 110, and may provide notifications 212 only for conversations to which the user 102 is not directing user attention 700. As a first example 704, if the device 104 detects that the user 102 is directing user attention 700 to the conversation 108 (e.g., if the user 102 is actively contributing to the audio conversation 110; if the gaze of the user 102 is following the audio conversation 110; and/or if the user 102 appears to be taking notes pertaining to the content of the audio conversation 110), then the device 104 may refrain from monitoring the audio conversation 110 and/or presenting notifications 212 upon detecting conversation cues 206 therein that pertain to the user 102, which might unhelpfully distract the user attention 700 of the user 102 and/or interrupt the audio conversation 110. As a second example 706, if the device 104 detects a lapse 702 of the user attention 707 of the user 102 (e.g., if the user 102 is not responding to conversation cues 206 such as the user's name, or if the user 102 appears to be distracted), then the device 104 may present notifications 212 of the conversation cues 206 arising within the audio conversation 110 in order to redirect the user attention 700 of the user 102 back to the audio conversation 110.

FIG. 8 presents an illustration of an exemplary scenario 800 featuring a fourth variation of this second aspect. In this exemplary scenario 800, the device 104 is configured to identify a conversation context 804 of an audio conversation 110 (e.g., the time, place, subject, medium, tone, participants, significance, and/or mood of the audio conversation 110), and may utilize the conversation context 804 to adjust the application of the techniques presented herein. More particularly, in this exemplary scenario 800, the device 104 adjusts the conversation cues 206 that the device 104 monitors 204 based on the conversation context 804 of the audio conversation 110. As a first such example, the device 104 may detect a first conversation 110 arising as a broadcast 802, such as an interview on a television. The device 104 may therefore not monitor 204 conversation cues 206 that are not likely to pertain to the user 102 in such an interview (e.g., a reference to the user's first name in the audio conversation 110 likely pertains to other individuals 108 instead of the user 102), and may monitor 204 conversation cues 206 that may arise within such an interview (e.g., a news broadcast may feature a first conversation cue 206 pertaining to the name of the user's school, or a second conversation cue 206 pertaining to a particular sports game in which the user 102 has an interest). Alternatively, the device 104 may be configured not to monitor audio conversations 110 that do not arise within physical proximity of the user 102 and/or that do not include the user 102, in order to avoid providing false notifications triggered by such media devices as televisions. For a second audio conversation 110 occurring between two individuals 108 in a second conversation context 804 comprising the user's classroom, the device 104 may monitor a different set of conversation cues 206 that are likely to pertain to the user 102 when arising in this conversation context 804, such as the user's first name and references to an examination. In this manner, the device 104 may adapt its monitoring 204 to the conversation context 804 of the audio conversation 110.

As a fifth variation of this second aspect, the device 104 may be configured to refrain from monitoring a particular audio conversation 202, e.g., in respect for the privacy of the user 102 and/or the sensitivity of the individuals 108 who engage in audio conversations 202 with or near the user 102. The capability of refraining from selected audio conversations 202 may safeguard the trust of the user 102 in the device 104, and/or the social relationship between the user 102 and other individuals 108. As a first such example, the device 104 may receive a request from the user 102 not to monitor a particular audio conversation 110, or a particular class of audio conversations 110 (e.g., those occurring at a particular time or place, or involving a particular set of individuals 108), and the device 104 may fulfill the request of the user 102.

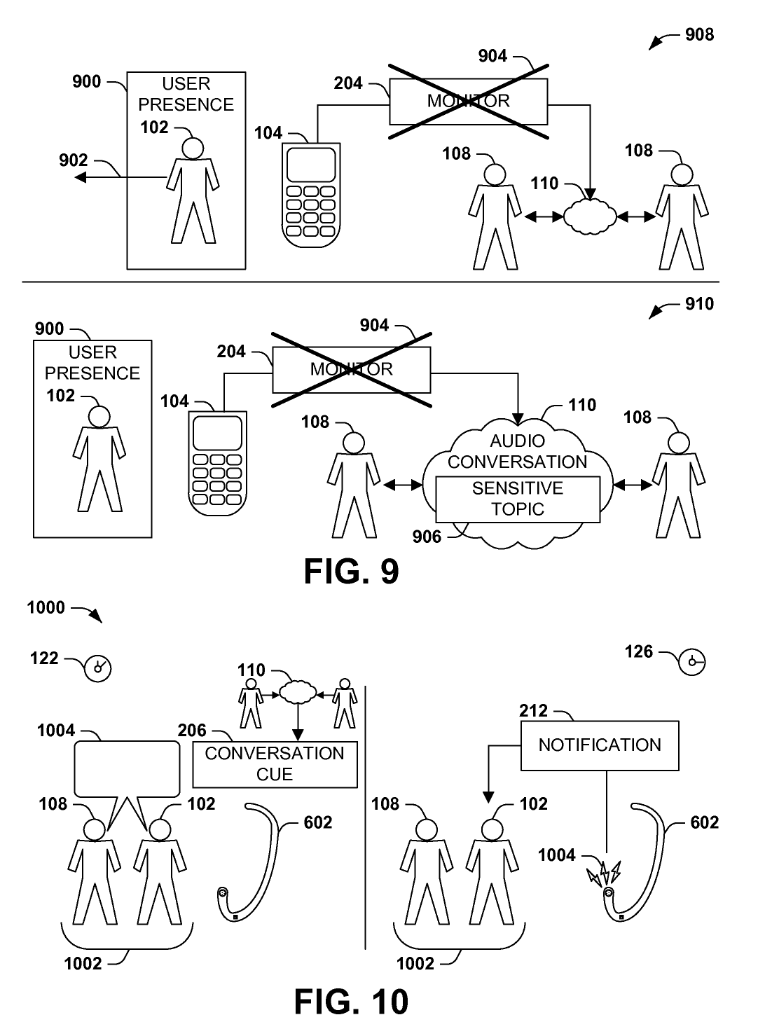

FIG. 9 presents two other examples of this fifth variation of this second aspect, in which the device 104 automatically determines that an audio conversation 110 is not to be monitored. As a first such example 908, the device 104 may, upon detecting an audio conversation 110, verify a user presence 900 of the user 102 with the device 104. For example, if the user 900 has set down the device 104 on a desk or table and has temporarily walked away 904 from the device 104, then the device 104 may determine the lack of user presence 900 of the user 102 and may refrain 904 from monitoring 204 an audio conversation 110 continuing between two or more individuals 108 outside of the presence of the user 102. As a second such example 910, the device 104 may be configured to refrain 904 from monitoring 204 an audio conversation 110 that pertains to a sensitive topic 906, e.g., a topic that the individuals 108 participating in the audio conversation 110 do not wish or intend to share with the device 104 and/or the user 102. The device 104 may therefore determine a user sensitivity level of the audio conversation 110 (e.g., identifying words of the audio conversation 110 that are often associated with sensitive topics, such as medical conditions), and may make a determination not to monitor 204 the audio conversation 110 while the user sensitivity level of the audio conversation 110 exceeds a user sensitivity threshold. The device 104 may periodically review the audio conversation 110 to determine an updated user sensitivity level, and may toggle the monitoring 204 of the audio conversation 110 as the topics of the audio conversation 110 shift among sensitive topics 906 and non-sensitive topics. These and other techniques may be utilized in the detection and monitoring 204 of audio conversations 110 among various individuals 108 and the user 102 in accordance with the techniques presented herein.

E3. Detecting Conversation Cues

A third aspect that may vary among embodiments of the techniques presented herein involves identifying the conversation cues 206 that are of interest to the user 102, and to detecting the conversation cues 206 within an audio conversation 110.

As a first variation of this third aspect, the conversation cues 206 that are of interest to the user 102 may be derived from various sources, such as the user's name; the names of the user's family members, friends, and colleagues; the names of locations that are relevant to the user 102, such as the user's city of residence; the names of organizations with which the user 102 is affiliated, such as the user's school or workplace; and the names of topics of interest to the user 102, such as particular activities, sports teams, movies, books, or musical groups in which the user 102 has expressed interest, such as in a user profile of the user 102. As one such variation, the device 104 may detect from the user 102 an expression of interest in a selected topic (e.g., a command from the user 102 to the device 104 to store a selected topic that is of interest to the user 102), or an engagement of the user 102 in discussion with another individual 108 about the selected topic, and may therefore record one or more conversation cues 206 that are associated with the selected topic for detection in subsequent audio conversations 202.

As a second variation of this third aspect, the conversation cues 206 that are of interest to the user 102 may be selected based on a current context of the user 102, e.g., a current task that is pertinent to the user 102. For example, if the user 102 is scheduled to travel by airplane to a particular destination location, the device 104 may store conversation cues 206 that relate to air travel (e.g., inclement weather conditions that are interfering with air travel), and/or that relate to the particular destination location (e.g., recent news stories arising at the destination location).

As a third variation of this third aspect, the device 104 may achieve the monitoring of the audio conversation 110 using a variety of techniques. As a first such example, the device 104 may translate the audio conversation 110 to a text transcript 118 (e.g., using a speech-to-text translator 116), and may evaluate the text transcript 118 to identify at least one keyword pertaining to the user 102 (e.g., detecting keywords that are associated with respective conversation cues 206, and/or applying lexical parsing to evaluate the flow of the audio conversation 110, such as detecting that an individual 108 is asking a question of the user 102). As a second such example, the device 104 may identify an audio waveform that corresponds to a particular conversation cue 206 (e.g., identifying a representative audio waveform of the user's name), and may then detect the presence of the audio waveform corresponding to the conversation cue 206 in the audio stream 202. As a third such example, the device 104 may evaluate the audio conversation 110 using natural language processing techniques to identify the topics arising within the audio conversation 110. Such topics may then be compared with the list of topics that are of interest to the user 102, e.g., in order to disambiguate the topics of the audio conversation 110 (e.g., determining whether an audio conversation 110 including the term “football” refers to American football, as a topic that is not of interest to the user 102, or to soccer, as a topic that is of interest of the user 102). Moreover, these and other techniques may be combined, such as in furtherance of the efficiency of the device 104; e.g., the device 104 may store a portion of the audio conversation 110 in an audio buffer, and, upon detecting a presence of the audio waveform of the user's name in the audio stream 202, may translate the audio conversation portion stored in the audio buffer into a text translation, in order to evaluate the audio conversation 110 and to notify the user 102 of communication cues 206 arising therewithin. Such variations may enable a conservation of the computing resources and stored power of the device 104, e.g., by performing a detailed evaluation of the audio conversation 110 only when an indication arises that the conversation 110 is likely to pertain tot the user 102. These and other variations in the monitoring of the audio conversation 110 to detect the conversation cues 206 may be included in embodiments of the techniques presented herein.

E4. Presenting Notifications

A fourth aspect that may vary among embodiments of the techniques presented herein involves presenting to the user 102 a notification 212 of the conversation cue 206 arising within the audio conversation.

As a first variation of this fourth aspect, the device 104 may present notifications 212 using a variety of output devices 416 and/or communication modalities, such as a visual notification embedded in eyewear; an audio notification presented by an earpiece; and a tactile indicator presented by a vibration component. The notification 212 may also comprise, e.g., the ignition of a light-emitting diode (LED); the playing of an audio cue, such as a tone or spoken word; a text or iconographic message presented on a display component; a vibration; and/or a text transcript of the portion of the audio conversation 110 that pertains to the user 102.

As a second variation of this fourth aspect, respective notifications 212 may signal many types of information, such as the presence of a communication cue 206 in the current audio conversation 110 of the user 102 (e.g., a question asked of the user 102 during a meeting when the user's attention is diverted), and/or a recommendation for the user 102 to redirect attention from a first audio conversation 110 to a second or selected audio conversation 110 that includes a conversation cue 206 pertaining to the user 102. Moreover, among at leas two concurrent audio conversations 110, the device 104 may perform a selection (e.g., determining which of the audio conversations 110 includes conversation cues 206 of a greater number and/or significance), and may notify the user of the selected audio conversation among the at least two concurrent audio conversations 110.

FIG. 10 presents an illustration of an exemplary scenario 1000 featuring a third variation of this fourth aspect, involving the timing of presenting a notification 212 to the user 102. In this exemplary scenario 1000, at a first time 122, the user 102 of an earpiece device 602 may be in the presence of a first individual 108 when the earpiece device 602 detects an occurrence of a conversation cue 206 in an audio conversation 110 held between two individuals 108 who are in proximity to the user 102. Moreover, the earpiece 604 monitors the interaction 1004 of the user 102 and the individual 108 to identify an audio notification of the conversation cue 206 to the user 102. However, at the first time 122, the user 102 may be directing user attention 700 into an interaction 1004 with the first individual 108, and presenting the notification 212 to the user 102 at the first time 122 may interrupt the interaction 1004. Accordingly, the earpiece device 602 may defer the presentation to the user 102 of a notification 212 of the conversation cue 206 until a second time 126, when the earpiece device 602 detects that the user 102 is no longer directing user attention 700 to the interaction 1004 (e.g., after the interaction 1004 with the first individual 108 ends, or during a break in an audio conversation with the first individual 108), and may then present the notification 212 to the user 102. Such deferral may be adapted, e.g., based on the priority of the conversation cue 206, such as the predicted user interest of the user 102 in the audio conversation 110 including the conversation cue 206, and/or the timing of the conversation cue 206; e.g., the earpiece device 602 may be configured to interrupt the interaction 1004 in the event of high-priority conversation cues 206 and/or conversation cues having a fleeting opportunity for participation by the user 102, and to defer other notifications 212 until a notification opportunity arises that avoids interrupting the interaction 1004 of the user 102 and the first individual 108. Many such scenarios may be included to monitor audio conversations 110 for conversation cues 206 in accordance with the techniques presented herein.

### F. Computing Environment

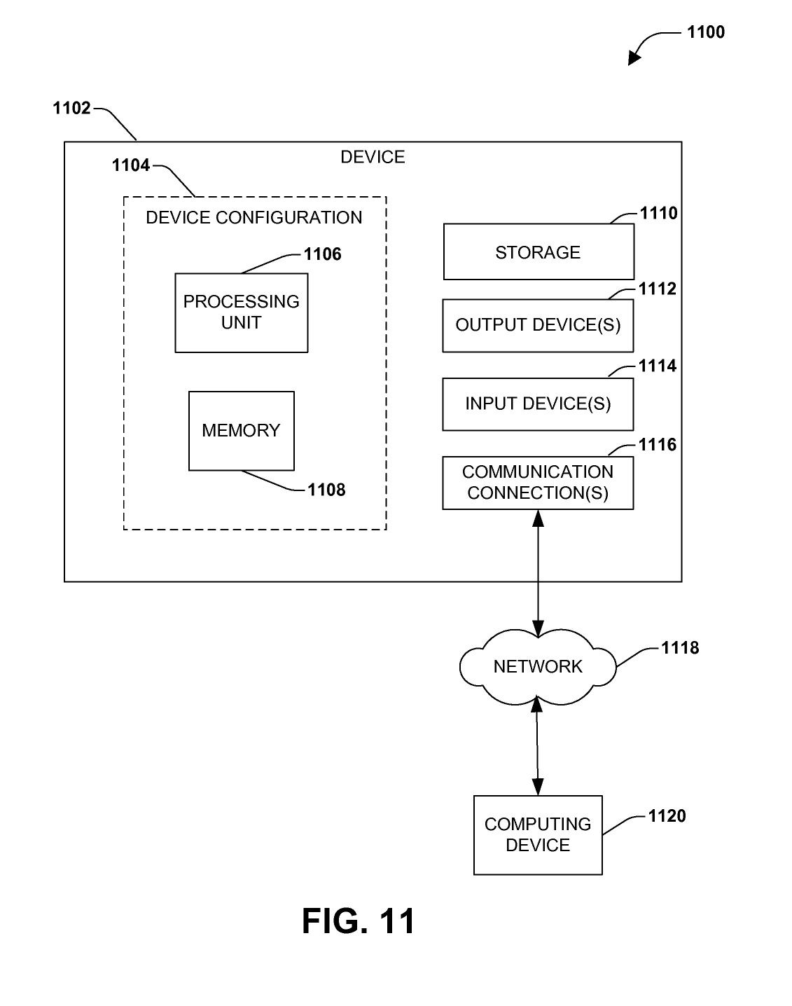

FIG. 11 and the following discussion provide a brief, general description of a suitable computing environment to implement embodiments of one or more of the provisions set forth herein. The operating environment of FIG. 11 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 11 illustrates an example of a system 1100 comprising a computing device 1102 configured to implement one or more embodiments provided herein. In one configuration, computing device 1102 includes at least one processing unit 1106 and memory 1108. Depending on the exact configuration and type of computing device, memory 1108 may be volatile (such as RAM, for example), non-volatile (such as ROM, flash memory, etc., for example) or some combination of the two. This configuration is illustrated in FIG. 11 by dashed line 1104.

In other embodiments, device 1102 may include additional features and/or functionality. For example, device 1102 may also include additional storage (e.g., removable and/or non-removable) including, but not limited to, magnetic storage, optical storage, and the like. Such additional storage is illustrated in FIG. 11 by storage 1110. In one embodiment, computer readable instructions to implement one or more embodiments provided herein may be in storage 1110. Storage 1110 may also store other computer readable instructions to implement an operating system, an application program, and the like. Computer readable instructions may be loaded in memory 1108 for execution by processing unit 1106, for example.

The term “computer readable media” as used herein includes computer-readable storage devices. Such computer-readable storage devices may be volatile and/or nonvolatile, removable and/or non-removable, and may involve various types of physical devices storing computer readable instructions or other data. Memory 1108 and storage 1110 are examples of computer storage media. Computer-storage storage devices include, but are not limited to, RAM, ROM, EEPROM, flash memory or other memory technology, CD-ROM, Digital Versatile Disks (DVDs) or other optical storage, magnetic cassettes, magnetic tape, and magnetic disk storage or other magnetic storage devices.

Device 1102 may also include communication connection(s) 1116 that allows device 1102 to communicate with other devices. Communication connection(s) 1116 may include, but is not limited to, a modem, a Network Interface Card (NIC), an integrated network interface, a radio frequency transmitter/receiver, an infrared port, a USB connection, or other interfaces for connecting computing device 1102 to other computing devices. Communication connection(s) 1116 may include a wired connection or a wireless connection. Communication connection(s) 1116 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 1102 may include input device(s) 1114 such as keyboard, mouse, pen, voice input device, touch input device, infrared cameras, video input devices, and/or any other input device. Output device(s) 1112 such as one or more displays, speakers, printers, and/or any other output device may also be included in device 1102. Input device(s) 1114 and output device(s) 1112 may be connected to device 1102 via a wired connection, wireless connection, or any combination thereof. In one embodiment, an input device or an output device from another computing device may be used as input device(s) 1114 or output device(s) 1112 for computing device 1102.

Components of computing device 1102 may be connected by various interconnects, such as a bus. Such interconnects may include a Peripheral Component Interconnect (PCI), such as PCI Express, a Universal Serial Bus (USB), Firewire (IEEE 1394), an optical bus structure, and the like. In another embodiment, components of computing device 1102 may be interconnected by a network. For example, memory 1108 may be comprised of multiple physical memory units located in different physical locations interconnected by a network.

Those skilled in the art will realize that storage devices utilized to store computer readable instructions may be distributed across a network. For example, a computing device 1120 accessible via network 1118 may store computer readable instructions to implement one or more embodiments provided herein. Computing device 1102 may access computing device 1120 and download a part or all of the computer readable instructions for execution. Alternatively, computing device 1102 may download pieces of the computer readable instructions, as needed, or some instructions may be executed at computing device 1102 and some at computing device 1120.

### G. Usage of Terms

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method of apprising a user about audio conversations on a device having a processor, the method comprising:
executing on the processor instructions that cause the device to:
evaluate an audio stream to detect an audio conversation;
monitor the audio conversation to detect a conversation cue pertaining to the user; and
upon detecting the conversation cue in the audio conversation, notify the user about the conversation cue in the audio conversation.

2. The method of claim 1, wherein:
evaluating the audio stream further comprises: evaluating the audio stream to distinguish a first audio conversation and a second audio conversation in the audio stream; and
monitoring the audio conversation further comprises: monitor the first audio conversation to detect, within the first audio conversation, a conversation cue pertaining to the user.

3. The method of claim 2, wherein:
distinguishing the first audio conversation and the second audio conversation further comprises:
determining that the user is directing attention to the second audio conversation, and
determining that the user is not directing attention to the first audio conversation; and
monitoring the first audio conversation further comprises:
monitoring the first audio conversation to which the user is not directing attention to detect the conversation cue pertaining to the user; and
refraining from monitoring the second audio conversation to which the user is directing attention.

4. The method of claim 2, wherein:
monitoring the audio conversation further comprises: monitoring the first audio conversation and the second conversation to detect, within a selected audio conversation, a conversation cue pertaining to the user; and
notifying the user further comprises: notifying the user of the selected audio conversation, among the first audio conversation and the second conversation, that comprises the conversation cue pertaining to the user.

5. The method of claim 1, wherein:
detecting the audio conversation further comprises: detecting an audio conversation context of the audio conversation; and
monitoring the audio conversation further comprises: monitoring the audio conversation to detect, within the audio conversation and according to the audio conversation context, the conversation cue pertaining to the user.

6. The method of claim 1, wherein:
executing the instructions on the processor further causes the device to, upon detecting from the user an expression of interest in a selected topic, identify at least one conversation cue that is associated with the selected topic; and
monitoring the audio conversation further comprises: monitoring the audio conversation to detect, within the audio conversation, the at least one conversation cue that is associated with the selected topic.

7. The method of claim 1, wherein executing the instructions on the processor further causes the device to identify the at least one conversation cue according to a user context of the user.

8. A system for apprising a user about audio conversations, the system comprising:
an audio monitor that:
detects an audio conversation within an audio stream, and
monitors the audio conversation to detect a conversation cue pertaining to the user; and
a communication notifier that, upon the audio monitor detecting the conversation cue in the audio conversation, notifies the user about the conversation cue in the audio conversation.

9. The system of claim 8, wherein:
the device is in communication with a user device;
the audio monitor further detects the audio conversation within the audio stream by receiving at least a portion of the audio stream from the user device; and
the communication notifier further notifies the user by notifying the user device about the conversation cue in the audio conversation.

10. The system of claim 8, wherein:
the device is in communication with a server;
monitoring the audio conversation further comprises: sending at least a portion of the audio stream to the server; and
detecting the conversation cue further comprises: receiving from the server a notification of the conversation cue within the audio stream.

11. The system of claim 8, wherein the audio monitor monitors the audio conversation by:
verifying a user presence of the user with the device; and
monitoring the audio conversation to detect the conversation cue pertaining to the user only upon verifying the user presence of the user with the device.

12. The system of claim 8, wherein the audio monitor monitors the audio conversation by: upon receiving from the user a request to refrain from monitoring the audio conversation, refraining from monitoring the audio conversation.

13. The system of claim 8, wherein the audio monitor monitors the audio conversation by:
determining a user sensitivity level of the audio conversation; and
while the user sensitivity level of the audio conversation exceeds a user sensitivity threshold, refraining from monitoring the audio conversation.

14. A memory device storing instructions that, when executed on a processor of a device of a user, apprise the user about conversations, by:
evaluating an audio stream to detect at least one conversation;
monitoring the at least one conversation to detect a conversation cue pertaining to the user; and
upon detecting the conversation cue in a selected conversation, notifying the user about the selected conversation.

15. The memory device of claim 14, wherein detecting the conversation cue in the audio conversation further comprises:
translating the audio conversation to a text transcript; and
evaluating the text transcript to identify at least one keyword pertaining to the user.

16. The memory device of claim 14, wherein detecting the conversation cue in the audio conversation further comprises:
identifying an audio waveform corresponding to the conversation cue; and
detecting a presence, within the audio conversation, of the audio waveform corresponding with the conversation cue.

17. The memory device of claim 14, wherein notifying the user about the conversation cue further comprises:
generating a text transcript of the audio conversation; and
presenting the text transcript of the audio conversation to the user.

18. The memory device of claim 17, wherein generating the text transcript further comprises:
storing an audio conversation portion of the audio conversation in an audio buffer; and
upon detecting the presence of the audio waveform corresponding to the conversation cue within the audio conversation, translating the audio conversation portion in the audio buffer into the text translation of the audio conversation.

19. The memory device of claim 14, wherein notifying the user about the conversation cue further comprises:
determining whether the user is directing attention to the audio conversation; and
upon determining that the user is not directing attention to the audio conversation, presenting to the user a notification that the audio conversation pertains to the user.

20. The memory device of claim 14, where notifying the user about the conversation cue further comprises:
detecting an audio notification opportunity when the user is not directing attention to an audio conversation; and
during the audio notification opportunity, presenting an audio notification of the conversation cue of the audio conversation.
